(19) United States
(12) Patent Application Publication
(10) Pub. No.: US 2011/0205691 A1
(43) Pub. Date: Aug. 25, 2011

(54) SOLID ELECTROLYTIC CAPACITOR AND A METHOD FOR MANUFACTURING THE SAME

(75) Inventors: Masayuki FUJITA, Kyoto-city (JP); Gaku HARADA, Kawanishi-city (JP); Yoshitaka NISHIO, Hirakata-city (JP); Koichi NISHIMURA, Kadoma-city (JP)

(73) Assignee: SANYO ELECTRIC CO., LTD., Moriguchi City (JP)

(21) Appl. No.: 13/032,034

(22) Filed: Feb. 22, 2011

(30) Foreign Application Priority Data
Feb. 25, 2010 (JP) 2010-040679

(51) Int. Cl. H01G 9/048; H01G 9/00

(52) U.S. Cl. 361/528; 29/25.03

(57) ABSTRACT

An aspect of the invention provides a solid electrolytic capacitor having an anode body, a dielectric layer formed on the anode body, and a conductive polymer layer formed on the dielectric layer, wherein the anode body including a porous body has a first surface and a second surface facing each other, and a through-hole from the first surface to the second surface, wherein the through-hole has a first outer circumference at the first surface and a second outer circumference at a cross-section that is parallel to the first surface, and the position of the second outer circumference viewed from a normal direction to the first surface differs from the position of the first outer circumference.

### CROSS REFERENCE TO RELATED APPLICATIONS

This application of the invention titled “SOLID ELECTROLYTIC CAPACITOR AND A METHOD FOR MANUFACTURING THE SAME” is based upon and claims the benefit of priority under 35 USC 119 from prior Japanese Patent Application No. 2010-040679, filed on Feb. 25, 2010; the entire contents of which are incorporated herein by reference.

### BACKGROUND OF THE INVENTION

1. Field of the Invention

The claimed invention relates to a solid electrolytic capacitor and a method for manufacturing the same. Especially, the claimed invention relates to a solid electrolytic capacitor comprising an anode made of a porous body, and a method for manufacturing the same.

2. Description Of Related Art

Solid electrolytic capacitors have been used widely in electronic apparatus such as communication devices like personal computers and cellular phones, and visual information devices like digital cameras.

In general, a solid electrolytic capacitor comprises an anode body including valve metals, a dielectric layer formed on the anode body, and a cathode layer formed on the dielectric layer. A preferable anode body is porous so that the anode body surface area per anode body volume is increased. The dielectric layer is formed on the surface of the porous body. A cathode layer is formed as a multiple layer body including a conductive polymer layer as an undermost layer. By having the conductive polymer layer in the undermost layer of the cathode layer, the cathode layer is more readily formed on the dielectric layer formed on the porous body. Consequently, a high capacitance can be achieved.

In recent years, solid electrolytic capacitors with even higher capacitance have become desirable. In order to obtain a solid electrolytic capacitor of higher capacitance, it is necessary to increase the anode body surface area to anode body volume ratio. For example, as a method for increasing the anode body surface area to anode body volume ratio, a method that minimizes the particle size of particles containing valve metals that are sintered into the anode body is commonly known.

However, even though the anode body surface area to anode body volume ratio is increased by minimizing the particle size, the capacitance does not necessarily increase proportionally to the increase of the anode body surface area. For example, Japanese publication laid-open 2008-277476 (“JP2008-277476”) describes a problem that the conductive polymer layer is not sufficiently formed on the dielectric layer located inside the anode body. This is because when particles of small particle sites are used for the anode body for sintering, materials forming the conductive polymer layer have trouble reaching inside the anode body. Further, JP2008.-277476 describes forming through-holes in the anode body so that materials for forming the conductive polymer layer can enter inside the anode body.

As described in JP-2008-277476, through-holes formed in the anode body allow materials for the conductive layer to readily reach inside the anode body. As a result, the conductive polymer layer is formed on the dielectric layer more readily. Thus, the capacitance of the solid electrolytic capacitor can be increased by forming through-holes in the anode body.

However, because of increasing demands for solid electrolytic capacitors of higher capacitance in recent years, even higher capacitance is desired for solid electrolytic capacitors.

### SUMMARY OF THE INVENTION

An aspect of the invention provides a solid electrolytic capacitor that includes an anode body, a dielectric layer, and conductive polymer layer. The anode body is made of a porous material. The anode body has a first surface and a second surface facing each other. The dielectric layer is formed on the anode body. The conductive polymer layer is formed on the dielectric layer. A through-hole is formed from the first surface to the second surface of the anode body. The through-hole has a first outer circumference at the first surface and a second outer circumference at a cross-section that is parallel to the first surface, and the position of the second outer circumference differs from the position of the first outer circumference in a view of a normal direction to the first surface.

As a result, in the aspect of the invention, the wall surface area of the through-hole (S) to through-bole volume ratio (S/V) increases. Accordingly, more materials for forming the dielectric layer readily penetrate inside the anode body through the through-hole. Thus, the coverage by the conductive polymer layer onto the dielectric layer located inside the anode body is increased.

Further, the wall surface area may be increased without significant decrease of the volume of the anode body, because the S/V value is large as explained above. Accordingly, the surface area per unit volume in the region where the anode body is provided (the sum of the anode body volume and volume of all through-holes) may be greatly increased. Thus, according to the aspect of the invention, a solid electrolytic having a low ESR and a high capacitance is obtained.

According to the aspect of the invention, the anode body may be formed into a cuboid-like body. Here, “cuboid-like body” refers to a cubic-like body having three pairs of surfaces that are facing each other. The cuboid-like body includes a body whose corner portions and ridge portions are chamfered or rounded, and a body whose facing surfaces are not exactly parallel to each other.

It is preferable that the through-hole has a plurality of through-hole portions with different center axes. In this case, the ratio (S/V) of wall surface area of through-hole (S) to through-hole volume (V) may be increased. Thus, according to the aspect of the invention, a solid electrolytic capacitor having a low ESR and a high capacitance is obtained.

Note that in the aspect of the invention, “the through-hole has a first outer circumference at the first surface and a second outer circumference at a cross-section that is parallel to the first surface, and the position of the second outer circumference differs from the position of the first outer circumference in a view of a normal direction to the first surface” means that at least the position or the shape of the outer circumference of the through-hole at the cross-section parallel to the first surface is different from that of the outer circumference of the opening of the through-hole at the first surface when the first surface is viewed from a normal direction.

Another aspect of the invention provides a solid electrolytic capacitor having an anode terminal connected to the outer surface of the anode body. In this case, it is preferable that one or more through-holes are formed in the anode terminal facing the anode body. In this configuration, materials for forming the conductive polymer layer are provided via the through-holes formed in the anode terminal onto the outer surface of the anode body, where the anode terminal is bonded Thus, the coverage by the conductive polymer layer on the dielectric layer formed inside the anode body is increased.

Further, it is preferable that the through-hole formed in the anode terminal corresponds to the through-hole formed in the anode body. This way, materials for forming the conductive polymer are readily provided in the through-holes formed in the anode body.

Further, in the aspect of the invention, the anode terminal may include a mesh-like member. Here, “mesh-like member” refers to a member made of braided conductive string-like members.

Yet another aspect of the invention provides a method of manufacturing a solid electrolytic capacitor that includes a step for preparing an anode body, a step for forming a dielectric layer, and a step for forming a conductive polymer layer. The step for forming an anode body includes preparing an anode body, wherein the anode body is made of a porous material and has a first surface and a second surface facing each other. Further, the anode body has a through-hole from the first surface to the second surface, wherein the through-hole has a first outer circumference at the first surface and a second outer circumference at a cross-section that is parallel to the first surface, and the position of the second outer circumference differs from the position of the first outer circumference in a view of a normal direction to the first surface. The step for forming a dielectric layer includes forming a dielectric layer on the anode body. The step for forming a conductive polymer layer includes forming a conductive polymer layer do the dielectric layer.

According to the method of manufacturing solid electrolytic capacitor in the aspect of the invention, a solid electrolytic capacitor having a low ESR and a high capacitance may be made.

Further, it is preferable that the step for preparing the anode body further includes a step for preparing a plurality of green sheets that include valve metal particles, a step for forming through-holes in each of the plurality of green sheets, a step for laminating the plurality of green sheets, and a step for sintering the laminated green sheets. Thus, an anode body having through-holes is obtained.

The green sheets having through-holes may be laminated in a manner that the center axis of the through-hole in each of the green sheets shifts in the laminating direction, so that the laminated body has a plurality of through-hole portions with different center axes. As a result, an anode body having a greater S/V value is formed. Thus, a solid electrolytic capacitor having a low ESR and a high capacitance is obtained.

### BRIEF DESCRIPTION OF THE DRAWINGS

FIG. 1 is a schematic cross-sectional view of a solid electrolytic capacitor according to a first embodiment.

FIG. 2 is a schematic cross-sectional view of the solid electrolytic capacitor taken along the II-II line in FIG. 1.

FIG. 3 is an enlarged schematic cross-sectional view of a vicinity of through-holes in the anode body taken along the III-III line in FIG. 2.

FIG. 4 is a schematic plan view of the anode body according to the first embodiment.

FIG. 5 is an enlarged schematic cross-sectional view of a part of a capacitor element according to the first embodiment.

FIG. 6 is a flow chart describing manufacturing steps of the solid electrolytic capacitor according to the first embodiment.

FIG. 7 is a schematic perspective view of a green sheet.

FIG. 8 is a schematic cross-sectional view of a laminated body of green sheets.

FIG. 9 is a schematic cross-sectional view of a solid electrolytic capacitor according to a second embodiment.

FIG. 10(a) is a schematic plan view of an anode body according to a first modified example.

FIG. 10(b) is a Schematic front view of the anode body according to the first modified example.

FIG. 10(c) is a schematic side view of the anode body according to the first modified example.

FIG. 11(a) is a schematic plan view of an anode body according to a second Modified example.

FIG. 11(b) is a schematic front view of the anode body according to the second modified example.

FIG. 11(c) is a schematic side view of the anode body according to the second modified example.

FIG. 12(a) is a schematic plan view of an anode body according to a third modified example.

FIG. 12(b) is a schematic front view of the anode body according to the third, modified example

FIG. 12(c) is a schematic side view of the anode body according to the third modified example.

FIG. 13(a) is a schematic plan view of an anode body according to a fourth modified example.

FIG. 13(b) is a schematic front view of the anode body according to the fourth modified example.

FIG. 13(c) is a schematic side view of the anode body according to the fourth modified example.

FIG. 14(a) is a schematic plan view of an anode body according to a fifth modified anode body.

FIG. 14(b) is a schematic front view of the anode body according to the fifth modified example.

FIG. 14(c) is a schematic side view of the anode body according to the fifth modified example.

FIG. 15(a) is a schematic plan view of an anode body according to a sixth modified anode body.

FIG. 15(b) is a schematic front view of the anode body according to the sixth modified anode body.

FIG. 15(c) is a schematic side view of the anode body according to the ‘sixth modified example.

FIG. 16(a) is a schematic plan view of an anode body according to a seventh modified example.

FIG. 16(b) is a schematic front view of the anode body according to the seventh modified example.

FIG. 16(c) is a schematic side view of the anode body according to the seventh modified example.

FIG. 17(a) is a schematic plan view of an anode body according to an eighth modified example.

FIG. 17(b) is a schematic front view of the anode body according to the eighth modified example.

FIG. 17(c) is a schematic side view of the anode body according to the eighth modified example.

FIG. 18(a) is a schematic plan view of an anode body according to a ninth modified example.

FIG. 18(b) is a schematic front view of the anode body according to the ninth modified example.

FIG. 18(c) is a schematic side view of the anode body according to the ninth modified example.

FIG. 19(a) is schematic plan view of an anode body according to a tenth modified example.

FIG. 19(b) is a schematic front view of the anode body according to the tenth modified example.

FIG. 19(c) is schematic side view of the anode body according to the tenth modified anode body.

FIG. 20(a) is a schematic plan view of an anode body according to an eleventh modified example.

FIG. 20(b) is a schematic front view of the anode body according to the eleventh modified example.

FIG. 20(c) is a schematic side view of the anode body according to the eleventh modified example.

### DETAILED DESCRIPTION OF EMBODIMENTS

Embodiments of the invention are explained with reference to the drawings. In the respective drawings referenced herein, the same constituents are designated by the same reference numerals and duplicate explanation concerning the same constituents is omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

Prepositions, such as “on”, “over” and “above” may be defined with respect to a surface, for example a layer surface, regardless of that surface's orientation in space. The preposition “above” may be used in the specification and claims even if a layer is in contact with another layer. The preposition “on” may be used in the specification and claims when a layer is not in contact with another layer, for example, when there is an intervening layer between them.

### First Embodiment

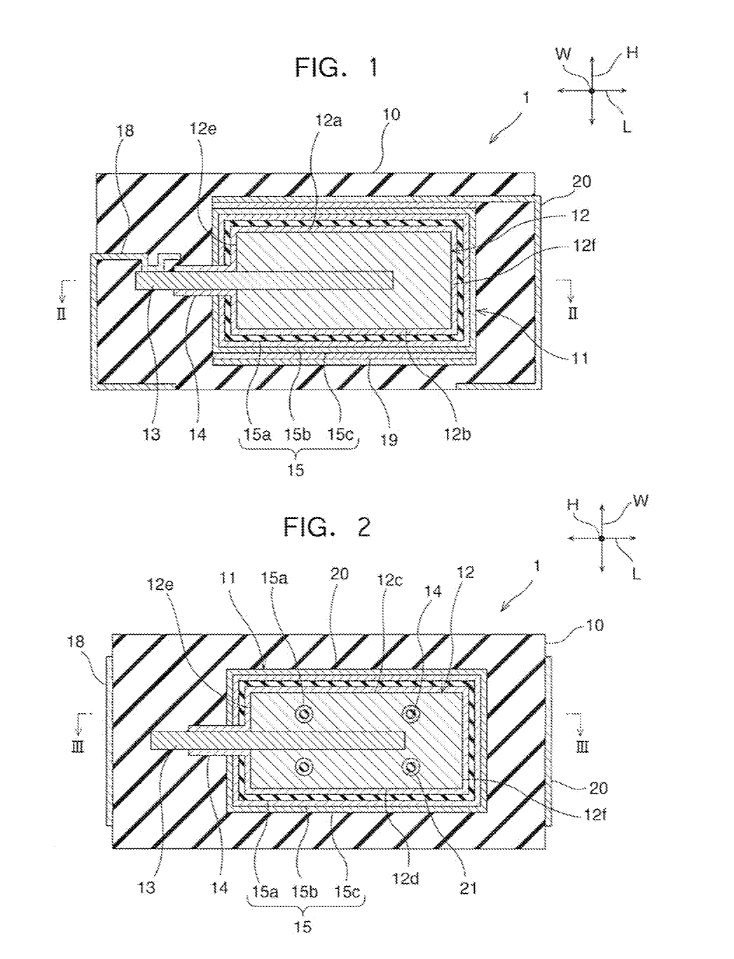

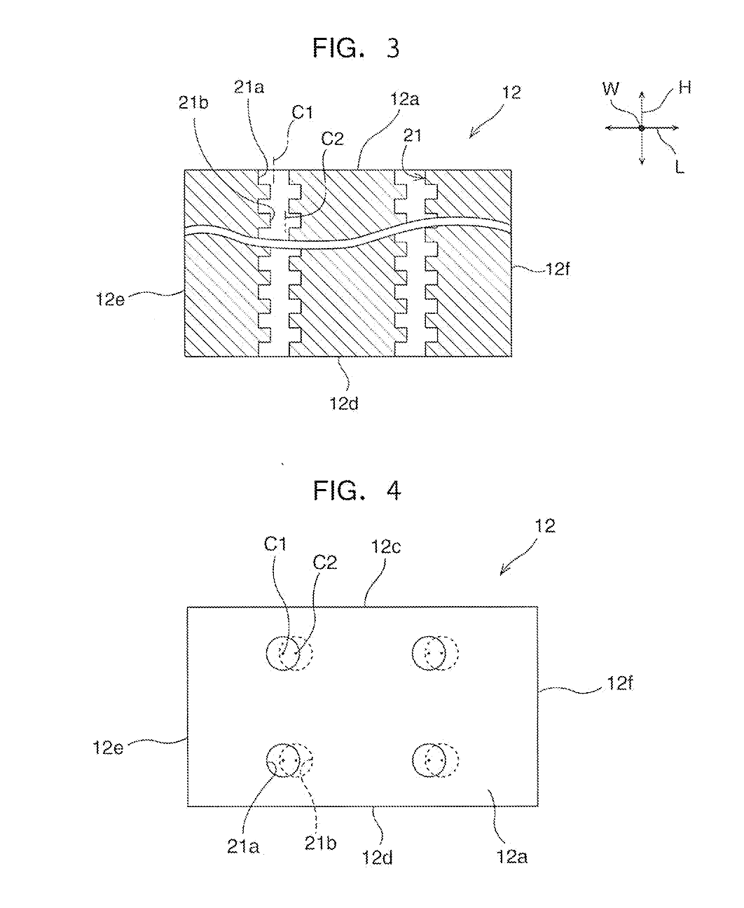

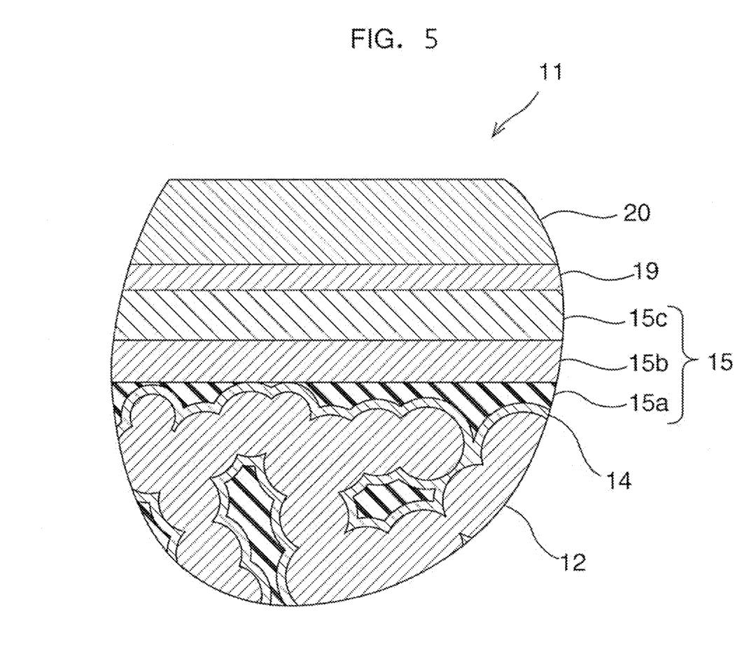

FIG. 1 is a Schematic cross-sectional view of a solid electrolytic capacitor according to a first embodiment. FIG. 2 is a schematic cross-sectional view of a solid electrolytic capacitor taken along the II-II line in FIG. 1. FIG. 3 is an enlarged schematic cross-sectional view in the vicinity of through-holes in an anode body taken along the III-III line in FIG. 2. FIG. 4 is a schematic plan view of an anode body according, to the first embodiment. FIG. 5 is an enlarged schematic cross-sectional view of a part of a capacitor element according to the first embodiment.

As shown in FIG. 1, solid electrolytic capacitor 1 contains capacitor element 11 having a cuboid-like body. Capacitor element 11 contains anode body 12. As shown in FIG. 5, anode body 12 is formed of a porous body containing valve metals. Specifically, the porous body forming anode body 12 may be made substantially of valve metals, alloys substantially containing valve metals, or substantially valve metal oxides such as niobium oxide. In case that the porous body forming anode body 12 is formed from alloys containing valve metals, such valve metals preferably make up more than 50% of the alloy weight.

Examples of the valve metals are niobium, tantalum, titanium, aluminum, hafnium, zirconium, zinc, tungsten, bismuth, antimony, and the like. Especially, using titanium, tantalum, aluminum, and niobium as valve metals is preferable because raw materials of these metals are readily available.

As shown in FIGS. 1-4, anode body 12 is formed into a cuboid body. Anode body 12 has first main surface 12a, second main surface 12b, first side surface 12c, second side surface 12d, first end surface 12e, and second end surface 12f. First main surface 12a and second main surface 12b extend in length direction (L) and in width direction (W). First main surface 12a and second main surface 12b are disposed in facing position to each other. First side surface 12c and second side surface 12d extend in length direction (L) and in height direction (H). First side surface 12c and second side surface 12d are in facing position to each other. First end surface 12e and second end surface 12f extend in width direction (W) and in height direction (H). First end surface 12e and second end surface 12f are disposed in facing position to each other.

In the following embodiment, anode body 12 whose facing surfaces are parallel to each other is used to explain the embodiment. Namely, each of first and second main surfaces (12a, 12b), first and second side surfaces (12c, 12d), and first and second end surfaces (12e, 12f), of anode body 12 are respectively parallel. However, the embodiment may use an anode body 12 with non-parallel facing surfaces. Namely, each of first and second main surfaces (12a, 12b), first and second side surface (12c, 12d), and first and second end surfaces (12e, 12f), of anode body 12 may not be parallel respectively. Moreover, each of first and second main surfaces (12a, 12b), first and second side surfaces (12c, 12d), and first and second end surfaces (12e, 12f) may be flat or non-flat. Moreover, corner portions and ridge portions of anode body 12 may be chamfered or rounded.

In the embodiment, a plurality of through-holes 21 are formed from first main surface 12a to second main surface 12b of anode body 12 as shown in FIGS. 2 and 3. Specifically, through-hole 21 has one end opened in first main surface 12a and another end opened in second main surface 12b. Here, the plurality of through-holes 21 may be disposed at equal intervals.

When first main surface 12a is viewed from a normal direction, the position of the outer circumference of through-hole 21 at first main surface 12a and the position of the outer circumference of through-hole 21 a cross-section that is parallel to first main surface 12a are different. Namely, at least the position or the shape of the outer circumference of through-hole 21 at the cross-section parallel to first main surface 12a is different from that of the outer circumference of the opening of through-hole 21 at first main surface 12a. Specifically, each of the plurality of through-holes 21 has a plurality of through-holes portions each having a center axis that are different from each other. More specifically, each of the plurality of through-holes 21 has a plurality of through-hole portions 21a that have first center axis C1, and a plurality of through-hole portions 21b that have second center axis C2 that is different from first center axis C1. Each one of the plurality of through-holes 21a and the plurality of through-holes 21b are arranged alternately in height direction H. Thus, each one of the plurality of through-hole 21a and the plurality of through-hole 21b are arranged in zigzag configuration around the axis in height direction H.

The distance between first center axis C1 and second center axis C2 is not limited. However, the distance between first center axis C1 and second center axis C2 may be determined by the overlapping area of through-hole portion 21a and through-hole portion 21b in a view of the normal direction to the first surface. For example, the preferable distance may be when the overlapping area is 10% to 90% of the sum of areas of through-hole portion 21a and through-hole portion 21b, or even more preferably, when the overlapping area is 30% to 70%. On one hand, if the distance between first center axis C1 and second center axis C2 is too short, the surface area of through-hole 21 may not s be large enough. On the other hand, if the distance between first center axis C1 and second center axis C2 is too great, materials for forming conductive polymer layer 15a occasionally do not flow smoothly into through-hole 21 because narrow portions become topically existent in through-hole 21.

In the embodiment, each of first center axis C1 and second center axis C2 is parallel to height direction H. However, each of first center axis C1 and second center axis C2 may be inclined to height direction H.

Moreover, in the embodiment, each of through-hole portion 21a and through-hole portion 21b is formed in a columnar shape, more specifically, in a circular cylinder shape. However, each of through-hole portion 21a and through-hole portion 21b may be formed in a polygonal columnar shape, an elliptical columnar shape, an oval columnar shape, and the like. Further, each, of through-hole portion 21a and through-hole portion 21b may be formed in a curved columnar shape with a curved center axis.

The size of through-hole 21 is not limited; however, it is preferable that the size is large enough to allow materials for forming conductive polymer layer 15a (to be explained later) to flow smoothly into through-hole 21. In this embodiment, a preferable diameter of through-hole portion 21a and through-hole portion 21b is approximately 0.3 mm to 0.7 mm, for example.

FIG. 2 shows a schematic view of the embodiment having four through-holes 21 formed in anode body 12; however, the number of through-holes 21 is not limited. The preferable number of through-holes 21 is when the ratio of the total volume of the plurality of through-holes 21 to the volume of a region where anode body 12 is provided is 0.05 to 0.15. Specifically, the number of through-holes 21 is, for example, 4 to 10.

As shown in FIGS. 1, 2, and 5, dielectric layer 14 which is made essentially of valve metal oxides is formed on the surface of anode body 12. Note that dielectric layer 14 in FIGS. 1 and 2 is described schematically for drawing conveniences. Actual dielectric layer 14 is formed not only on the outer surface of anode body 12, but also formed on the surface that is facing apertures (hereinafter “inner surface”) inside anode body 12 as shown in FIG. 5. Also, as shown in FIG. 2, dielectric layer 14 is also formed on the inner surface of through-hole 21.

A preferable thickness of dielectric layer 14 is, for example, approximately 10 nm to 500 nm. If dielectric layer 14 is too thick, the capacitance tends to decrease and dielectric layer 14 tends to delaminate from anode body 12. If dielectric layer 14 is too thin, the voltage resistance tends to drop and leakage current tends to increase.

Cathode layer 15 is formed on dielectric layer 14 as shown in FIGS. 1, 2, and 5. Cathode layer 15 includes conductive polymer layer 15a. Specifically, in the embodiment, cathode layer 15 is formed by a laminated body composed of conductive polymer layer 15a, carbon layer 15b, and silver paste layer 15c. In the embodiment, the cathode layer is not limited to anything specific, as long as the cathode layer includes a conductive polymer layer. For example, the cathode layer may be formed by a conductive polymer layer only, or formed by a conductive polymer layer and either a carbon layer or a silver paste layer.

Conductive polymer layer 15a is formed on dielectric layer 14. In particular, conductive polymer layer 15a is also formed inside anode body 12 as shown in FIG. 5. In other words, conductive polymer layer 15a is formed not only on dielectric layer 14 which is formed on the outer surface of anode body 12, but also formed on dielectric layer 14 that is formed on the inner surface of anode body 12. Of course, conductive polymer layer 15a is also formed on dielectric layer 14 that is formed on the inner wall of through-holes 21. In the embodiment, the inside of through-holes 21 is filled with dielectric layer 14 and conductive polymer layer 15a.

Conductive polymer layer 15a is formed by conductive polymers such as polypyrrole, poly(3,4-ethylenedioxythiophene), polythiophene, and polyaniline.

Carbon layer 15b is formed on conductive polymer layer 15a. In particular, carbon layer 15b is formed on a portion where conductive polymer layer 15a is formed on an outer surface of anode body 12. Silver paste layer 15c is formed on carbon layer 15b.

A portion of anode terminal 13 is embedded in anode body 12. Specifically, a portion of anode terminal 13 is embedded into first end face 12e of anode body 12. An end portion of anode terminal 13 is led, into anode body 12, thereby connecting to anode body 12. The other end of anode terminal 13 is connected to an end of anode lead frame 18.

Cathode layer 15 is connected to cathode lead frame 20 via conductive adhesive 19. An example of conductive adhesive 19 may be a silver paste containing silver particles, but it is not particularly limited.

Capacitor element 11 and anode terminal 13 are molded With resin. In other words, capacitor element 11 and anode terminal 13 are covered by resin outer package 10. Thus, resin outer package 10 seals capacitor element 11 and anode terminal 13.

As long as resin outer package 10 seals capacitor element 11, materials for resin outer package 10 are not particularly limited. For example, resin outer package 10 may be formed by a thermosetting resin composition that is commonly used as a sealant for electronic components. Examples of thermosetting resins are epoxy resins and the like.

Note that thermosetting resin compositions commonly used as a sealant for electronic components generally include fillers such as silica particles, curing agents such as phenolic resins, curing accelerators such as imidazole compounds, flexing agents such as silicone resin.

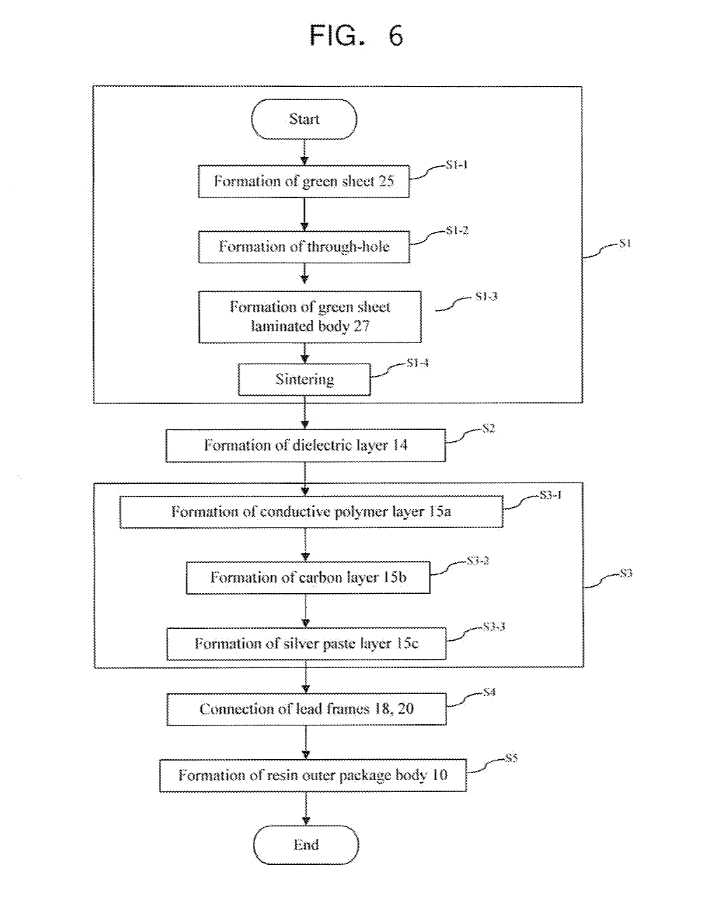

Next, an example of a method for manufacturing solid electrolytic capacitor 1 according to the embodiment is explained with reference mainly to FIGS. 6-8.

FIG. 6 is a flow chart describing manufacturing processes for solid electrolytic capacitor according to the first embodiment.

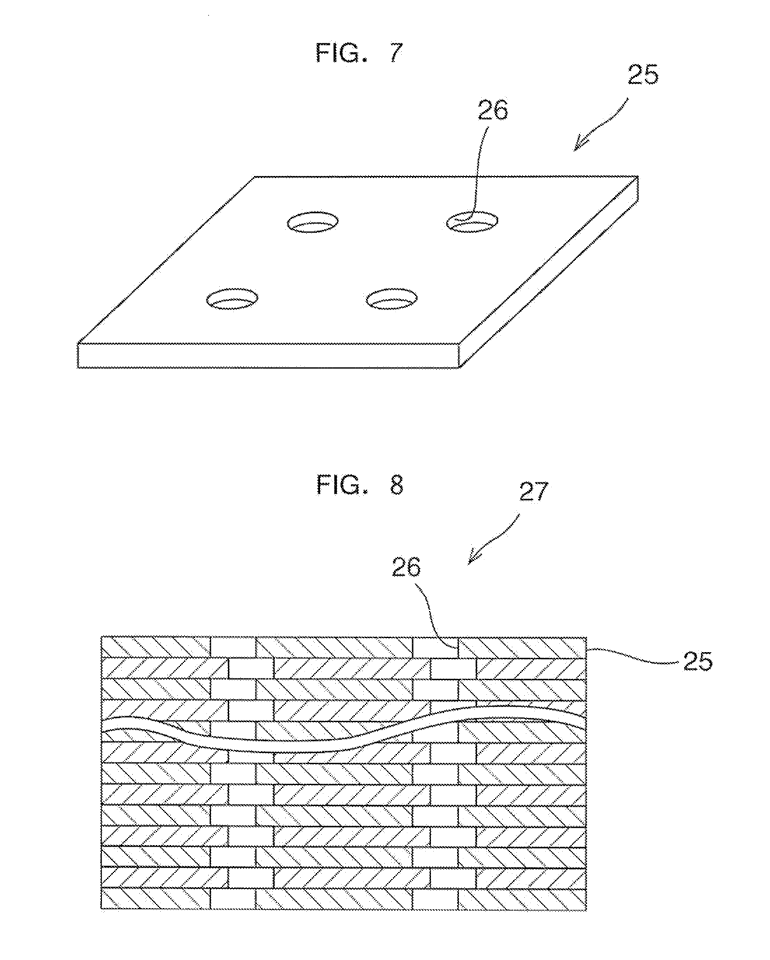

As shown in FIG. 6, step S1 is an anode body preparation step. Specifically, in step S1-1, a plurality of green sheets 25 containing valve metal particles (see FIG. 7) are prepared. Methods for forming a green sheet are not particularly limited. Green sheet 25, for example, is formed by a doctor blade method and the like, by using a paste made of a mixture of a binder and particles containing valve metals. The particle size of particles containing valve metals used to fabricate a green sheet 25 is, preferably 0.08 μm to 1 μm, and more preferably is 0.2 μm to 0.5 μm, for example. If the particle size is too large, the Surface area per resulting unit volume of anode body 12 tends to be small. On the contrary, if the particle size is too small, apertures formed in the porous body tend to be too small.

A binder used to fabricate green sheet 25 is, for instance, polyvinyl alcohol (PVA), polyvinyl butyral polyvinyl acetate, a mixture of acrylic resin and organic resin, and the like.

Next, in step S1-2 shown in FIG. 7, a plurality of through-holes 26 are formed in each of a plurality of green sheets 25. The method for forming through-hole 26 is not particularly limited. For example, through-holes 26 may be formed by punching out a green sheet 25 using punching needles.

Next, in step S1-3 shown in FIG. 6, green sheet laminated body 27 is formed, as shown in FIG. 8, by stacking green sheets 25 having through-holes 26. In step S1-3, green sheets 25 are laminated in a manner that the center axis of through-holes 26 in every adjacent green sheet 25 is misaligned in a stacking direction. Moreover, every several green sheets 25 may be laminated together in a manner that the center axis of through-holes 26 in every adjacent several green sheets 25 is misaligned in a stacking direction.

The manner of stacking green sheets 25 may be determined arbitrarily depending on the shape of through-hole 21.

Thereafter, isostatic pressing and the like is performed on green sheet laminated body 27, if necessary. Then, green sheet laminated body 27 is cut into the desired size.

Next, in step S1-4 shown in FIG. 6, anode body 12 in which through-holes 21 are formed (see FIG. 3) is obtained by sintering green sheet laminated body 27. A sintering temperature for green sheet laminated body 27 may be appropriately set, for example, depending on the type of valve metals contained in particles used for fabricating green sheet 25 and the particle sizes. The sintering temperature for green sheet laminated body 27 may be, for example, approximately 900° C. to 1300° C. If the temperature for sintering green sheet laminated body 27 is too low, the binder and the like may remain unprocessed. If the sintering temperature is too high, such an excess sintering may cause a fewer number of apertures to be formed inside anode body 12.

Note that in the embodiment, during the aforementioned step S1-3 wherein green sheet laminated body 27 is prepared, a portion of anode terminal 13 is embedded in green sheet laminated body 27. Thus, in step S1, anode body 12 having a portion of anode terminal 13 embedded within is prepared.

Following step S1 shown in FIG. 6, step S2 is performed. In step S2, dielectric layer 14 is formed on the surface of anode body 12. Dielectric layer 14 is formed, for example, by anodizing anode body 12 in an aqueous solution of phosphoric acid (i.e., anodization process.)

Next, in step S3, cathode layer 15 is formed on dielectric layer 14. More specifically, first, conductive polymer layer 15a is formed in step S3-1. Conductive polymer layer 15a is formed, for example, through a chemical polymerization or through an electropolymerization. For instance, in case that the chemical polymerization method is employed, conductive polymer layer 15a is formed through an oxidative polymerization of monomers with using an oxidizing agent.

In the following, formation of conductive polymer layer 15a by a chemical polymerization method is described in detail. First, an oxidizing agent is deposited on dielectric layer 14 of anode body 12. Then, anode body 12 with the deposit of the oxidizing agent is immersed in a solution in which monomers are dissolved. Alternatively, anode body 12 with the deposit of the oxidizing agent is exposed to an atmosphere that includes monomers. Polymerization of the monomers on dielectric layer 14 proceeds in this procedure, and thus, conductive polymer layer 15a is formed. In case that an even thicker conductive polymer layer 15a is needed, the procedure of immersing into the monomer solution or exposing to the monomer atmosphere may be performed repeatedly.

Further, a reanodization process may be performed after forming conductive polymer layer 15a. By doing so, dielectric layer 14 that is degraded during the conductive polymer layer 15a forming process may be repaired. Accordingly, the leakage current is possibly reduced.

Note that a pre-coat layer may be formed prior to the formation of conductive polymer layer 15a. In addition, a reanodization process may be performed after forming a pre-coat layer, then conductive polymer layer 15a may be formed. As a pre-coat layer, for example, polypyrrole membrane may be formed.

Next, in step S3-2, carbon layer 15b is formed. Specifically, a carbon paste is applied on conductive polymer layer 15a. Then, by drying the carbon paste, carbon layer 15b is formed.

Then, in step S3-3, silver paste is applied on carbon layer 15b. Then, by drying the silver paste, silver paste layer 15c is formed. Thereafter, an end portion of anode terminal 13 is exposed by removing dielectric layer 14, conductive polymer layer 15a, carbon layer 15b, and silver paste layers 15c formed on the end portion of anode terminal 13.

Next, in step S4, anode lead frame 18 and cathode lead frame 20 are connected. Then, in step S5, resin outer package body 10 is formed to finish solid electrolytic capacitor 1.

As explained above, in the embodiment, when first main surface 12a is viewed from a normal direction, the position of the outer circumference of through-hole 21 at first main surface 12a and the position of the outer circumference of through-hole 21 at a cross-section that is parallel to first main surface 12a are different. Namely, at least the position or the shape of the outer circumference of through-hole 21 at the cross-section parallel to first main surface 12a is different from that of the outer circumference of the opening of through-hole 21 at first main surface 12a. Therefore, portions of the wall surfaces of through-hale 21 are inevitably inclined to a normal direction (i.e., height direction H in the embodiment.) In the embodiment, because through-holes 21 have first through-hole portion 21a and second through-hole portion 21b each having different center axes, a surface that is perpendicular to height direction H is formed between first through-hole portion 21a and second through-hole portion 21b. Accordingly, in this embodiment, the surface area to volume ratio (S/V) (namely, wall surface area of through-hole 21 (S) to volume of through-hole 21(V) ratio) becomes greater than that of cylinder-shaped through-holes having a single center axis extending to height direction H.

For instance, in the embodiment, only the surface area that is perpendicular to height direction H out of the total wall surface area of through-hole 21 (S) increases; however, the volume of through-hole 21 (V) remains unchanged.

Specifically, if the height of through-holes 21 is four times larger than the radius of through-holes 21, such that the height of through-holes 21 is 1.0 mm and the radius of through-holes 21 is 0.25 mm, and further, the total number of through-hole portions 21a and 21b is four, the surface area of through-hole 21 is approximately 1.46 times greater than that of cylinder-shaped through-holes of the same height and the same radius.

Moreover, for example, if the height of through-holes 21 is four times larger than the radius of through-holes 21, such that the height of through-holes 21 is 1.0 mm and the radius of through-holes 21 is 0.25 mm, and further, the total number of through-hole portions 21a and 21b is ten, the surface area of through-hole 21 is approximately 2.37 times greater than that of cylinder-shaped through-holes 21 of the same height and the same radius.

As described above, the surface area of through-hole 21 can be increased without changing the volume of through-hole 21 by increasing the total number of first through-hole portions 21a and second through-hole portions 21b.

As a result, materials for forming conductive polymer layer 15a such as oxidizing agents and monomers more readily penetrate inside anode body 12 through the wall surface of through-hole 21. Accordingly, the coverage ratio of the area of dielectric layer 14 disposed inside anode body 12 that is covered with conductive polymer layer 15a is possibly increased.

In general, there are other methods of introducing more conductive polymer layer materials inside anode body 12 such as by increasing the diameter of the cylinder-shaped through-hole or by increasing the number of the cylinder-shaped through-holes. That way, the surface area of the through-hole may be increased. However, when the through-hole is formed in a cylinder shape, the surface area to volume ratio (S/V) is constant. In other words, when the size or the number of the through-holes is increased, the surface area of the through-hole can be increased; however, the volume of the through-hole is also increased along with the increased surface area. Accordingly, the ratio of the anode body volume in the region where the anode body is disposed is decreased. As a result, the surface area of the anode body is decreased. Consequently, when the size or the number of the cylinder-shaped through-hole is increased, materials for forming the conductive polymer layer may readily penetrate inside the anode body; however, because the surface area of the anode body is decreased, rather less capacitance is obtained.

In contrast, through-hole 21 in this embodiment has a shape that has a large surface area to volume ratio (S/V). Accordingly, materials for forming conductive polymer layer readily penetrate inside anode body 12 while the volume and the surface area of anode body 12 are decreased less. As a result, a high capacitance can be obtained.

Further, in this, embodiment, a lower ESR can be maintained because the coverage of conductive polymer layer 15a on dielectric layer 14 disposed inside anode body 12 is increased.

Followings are explanations of other examples or modified examples of a preferred embodiment that implement the above-mentioned embodiment. In the following descriptions, members having substantially the same functions as in the above-mentioned first embodiment should be understood as having such functions, and the explanations of such members are omitted.

### Second Embodiment

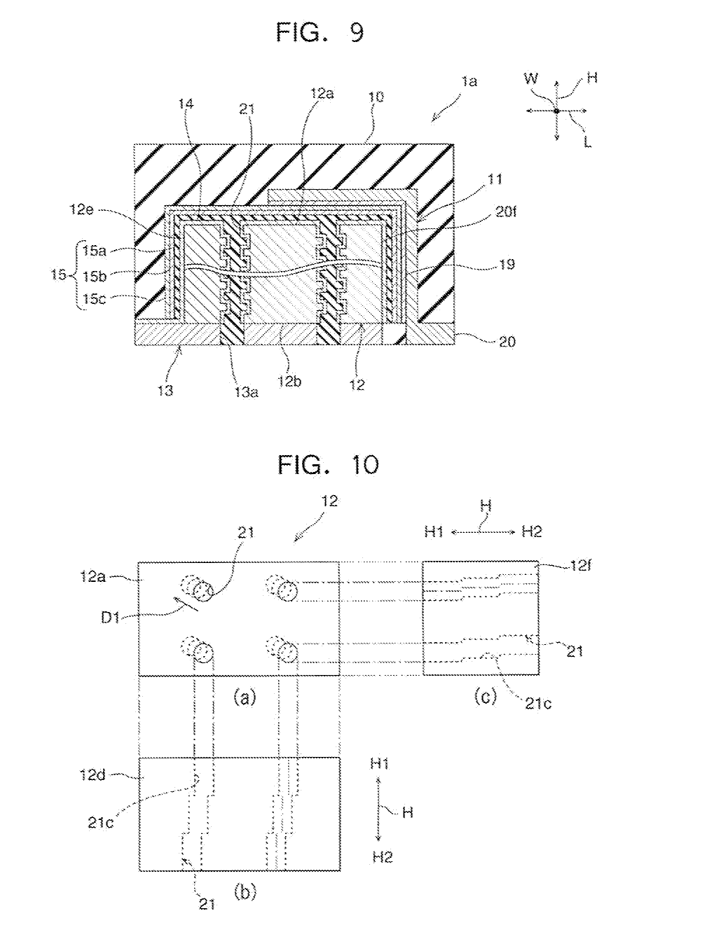

FIG. 9 is a schematic cross-sectional view of a solid electrolytic capacitor 1a according to a second embodiment.

In the first embodiment, an example where a portion of an end of anode terminal 13 is embedded in anode body 12 is explained. However, the shape of anode body 13 in the second embodiment is not particularly limited.

For example, anode terminal 13 may be connected to an outer surface of anode body 12 as shown in FIG. 9. Specifically, anode terminal 13 is bonded to second main surface 12b of anode body 12 in this embodiment.

In case anode terminal 13 is bonded on the outer surface of anode body 12, it is preferable that one or more through-holes 13a are formed in anode terminal 13. By forming through-hole 13a, materials for forming conductive polymer layer 15a are also provided onto second main surface 12b where anode terminal 13 is bonded. Thus, the coverage by conductive polymer layer 15a on dielectric layer 14 formed inside anode body 12 is increased. Consequently, a higher capacitance as well as a lower ESR may be obtained.

Further, it is preferable that through-hole 13a be connected to through-hole 21. For example, when an end portion of through-hole 21 at the second main surface 12b side is blocked by anode terminal 13, materials for forming conductive polymer layer 15a have trouble flowing into through-hole 21. In contrast, when through-hole 13a is connected to through-hole 21, materials for forming conductive polymer layer 15a readily flow into through-hole 21. Thus, the coverage by conductive polymer layer 15a on dielectric layer 14 formed inside anode body 12 is increased. Consequently, a higher capacitance as well as a lower ESR may be obtained.

In the embodiment, examples are explained by using anode terminal 13 made of a metal plate on which a plurality of through-holes 13a are formed. However, the embodiment is not limited to this configuration. Anode terminal 13, for example, may be a mesh-like member made of braided conductive string-like members. In this case, materials for forming conductive polymer layer 15a may be more readily provided to anode body 12 via anode terminal 13. Thus, the coverage by conductive polymer layer 15a on dielectric layer 14 formed inside anode body 12 is increased. Consequently, a higher capacitance as well as a lower ESR may be obtained.

In the following modified examples 1-11, variations of through-hole 21 formed in anode body 12 are explained. In the modified examples 1-11, embodiments of members except anode terminal 13 and the like are the same as that in the above-mentioned first or second embodiment.

Note that FIGS. 10-20 referred in modified embodiments 1-11 are schematically drawn. Specifically, as a matter of drawing convenience, the number of the through-holes drawn in the figures may be different from the actual number of through-holes.

### FIRST MODIFIED EXAMPLE

FIG. 10(a) is a schematic plan view of an anode body according to a first modified example. FIG. 10(b) is a schematic front view of the anode body according to the first modified example. FIG. 10(c) is a schematic side view of the anode body according to the first modified example.

In the first and second embodiments explained above, examples having through-holes 21 with two kinds of through-hole portions 21a and 21b and having the same shapes are arranged in zigzag configuration around an axis in height direction H. However, the shape of through-hole 21 is not limited to the configuration.

For example, a plurality of through-holes 21 may be formed by a plurality of through-hole portions 21c with different center axes as shown in FIGS. 10(a)-10(c). In this modified example, specifically, the center axis of a plurality of through-hole portions 21c shifts toward direction D1 that is inclined to each of width direction W and length direction L as the center axis extends from H1 to H2 in height direction H.

In this modified example, because the surface area volume ratio (S/V) increases, a similar effect as described in the first and second embodiments above is also obtained.

Note that in the modified example, the magnitude of the shift of a plurality of through-hole portions 21c toward direction D1 is constant. Here, direction D1 is a direction toward height H (from H1 side to H2 side) of the center axes of a plurality of through-hole portion 21c. However, the magnitude of the shift of a plurality of through-hole portions 21c toward direction D1 may not be constant.

### SECOND MODIFIED EXAMPLE

FIG. 11(a) is a schematic plan view of an anode body according to a second modified example. FIG. 11(b) is a schematic front view of the anode body according to the second modified example. FIG. 11(c) is a schematic side view of the anode body according to the second modified example.

In the first modified example, an example that has a plurality of through-holes 21 arranged in a parallel configuration is explained. However, the embodiment is not limited to this configuration.

For example, at least one of a plurality of through-holes 21 may be arranged non-parallel with other through-holes 21 as shown in FIGS. 11(a)-11(c). Specifically, in the modified example, through-holes 21 where the center axes of a plurality of through-hole portions 21c shift toward direction D2 in height direction H extending from H1 side to H2 side, and trough-hole 21 where the center axes of a plurality of through-hole portion 21c shift toward direction D3 that is different from direction D2 extending from Hi to H2 in height direction H, are formed.

### THIRD AND FOURTH MODIFIED EXAMPLES

FIG. 12(a) is a schematic plan view of an anode body according to a third modified example. FIG. 12(b) is a schematic front view of the anode body according to the third modified example. FIG. 12(c) is a schematic side view of the anode body according to the third modified example.

FIG. 13(a) is a schematic plan view of an anode body according to a fourth modified example. FIG. 13(b) is a schematic front view of the anode body according to the fourth modified example. FIG. 13(c) is a schematic side view of the anode body according to the fourth modified example.

In the first and second modified examples above, the center axis of a plurality of through-hole portions 21c is linearly shifted in height direction H from H1 side to H2 side. However, the embodiment is not limited to this configuration.

For example, the center axes of a plurality of through-hole portions 21c may be nonlinearly shifted in height direction H from H1 side to H2 side as shown in FIGS. 12(a)-12(c) and FIGS. 13(a)-13(c).

Specifically, in the modified examples FIGS. 12(a)-12(c), the center axes of a plurality of through-hole portions 21c shift toward direction D4, then shift toward direction D5 from H1 to H2 in height direction H.

In the modified examples FIGS. 13(a)-13(c), the center axes of a plurality of through-hole portions 21c shift toward direction D6, then shift toward directions D7 and D8 from H1 to H2 in height direction H.

### FIFTH AND SIXTH MODIFIED EXAMPLES

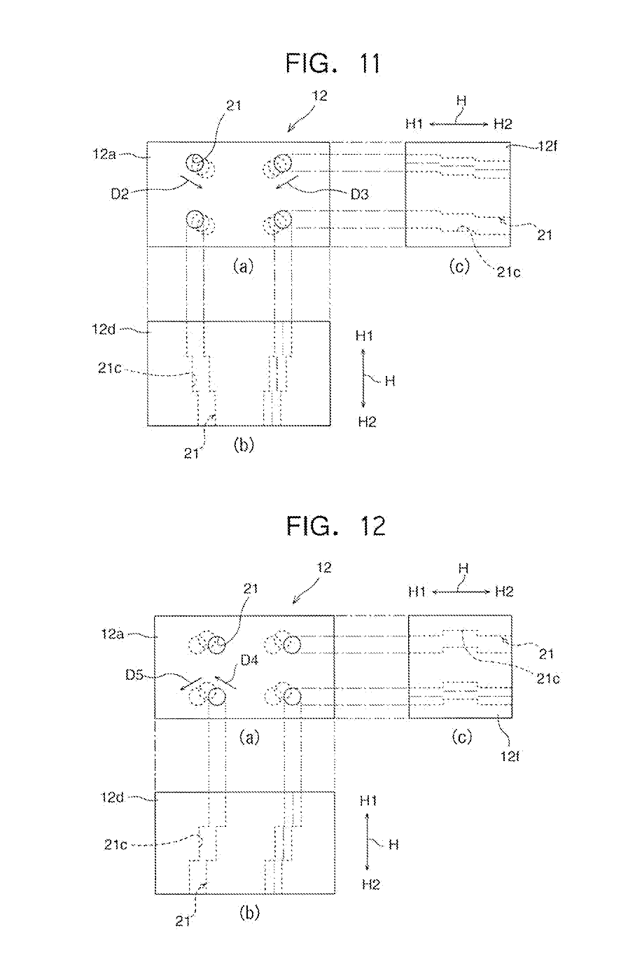

FIG. 14(a) is a schematic plan view of an anode body according to a fifth modified example. FIG. 14(b) is a schematic front view of the anode body according to the fifth modified example. FIG. 14(c) is a schematic side view of the anode body according to the fifth modified example.

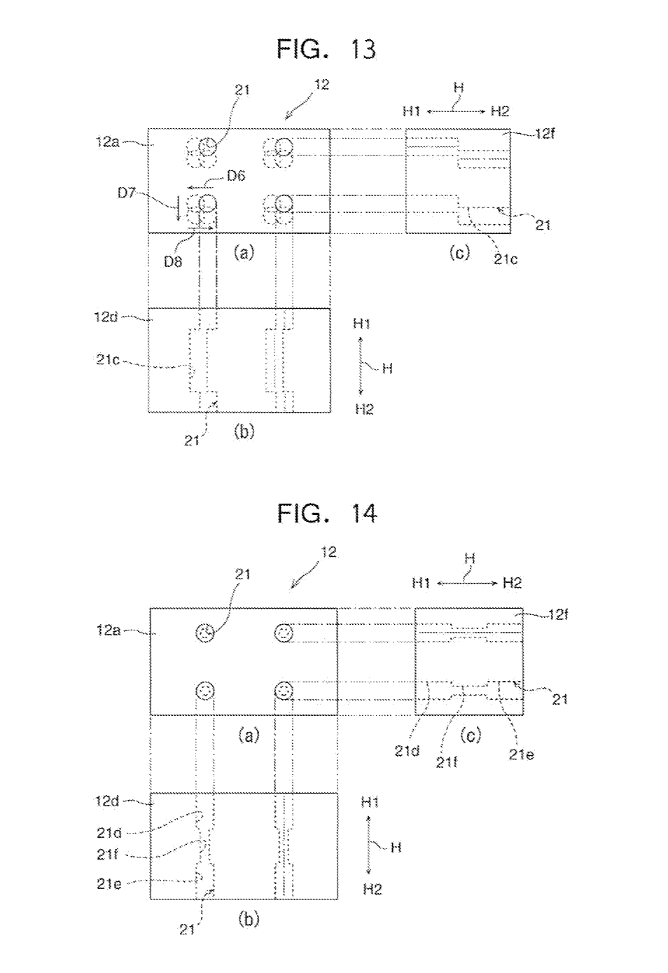

FIG. 15(a) is a schematic plan view of an anode body according to a sixth modified example. FIG. 15(b) is a schematic front view of the anode body according to the sixth modified example. FIG. 15(c) is a schematic side view of the anode body according to the sixth modified example.

In the first and the second embodiments and the first to the forth modified examples, the diameter of the through-hole portions is unchanged. However, a plurality of the through-hole portions that make up through-holes 21 may include different diameters from that of other through-hole portions as shown in FIGS. 14(a)-14(c) and FIGS. 15(a)-15(c).

Specifically, in the fifth modified example shown in FIGS. 14(a)-14(c), through-hole 21 has through-hole portion 21f that has a smaller diameter than that of other through-hole portions 21d and 21e. Through-hole portion 21f is disposed at a center region in height direction H. Note that in the modified example, through-hole portions 21d-21f have a common center axis. However, at least one of through-hole portions 21d-21f may have a different center axis from that of other through-hole portions.

In the sixth modified example shown in FIGS. 15(a)-15(c), through-hole 21 has through-hole portion 21i that has a larger diameter than that of other through-hole portions 21g and 21h. Through-hole portion 211 is disposed at a center region in height direction H. Not that in the modified example, through-hole portions 21g-21i have a common center axis. However, at least one of through-hole portions 21g-21i may have a different center axis from that of other through-hole portions.

### SEVENTH TO ELEVENTH MODIFIED EXAMPLES

FIG. 16(a) is a schematic plan view of an anode body according to seventh modified example. FIG. 16(b) is a schematic front view of the anode body according to the seventh modified example. FIG. 16(c) is a schematic side view of the anode body according to the seventh modified example.

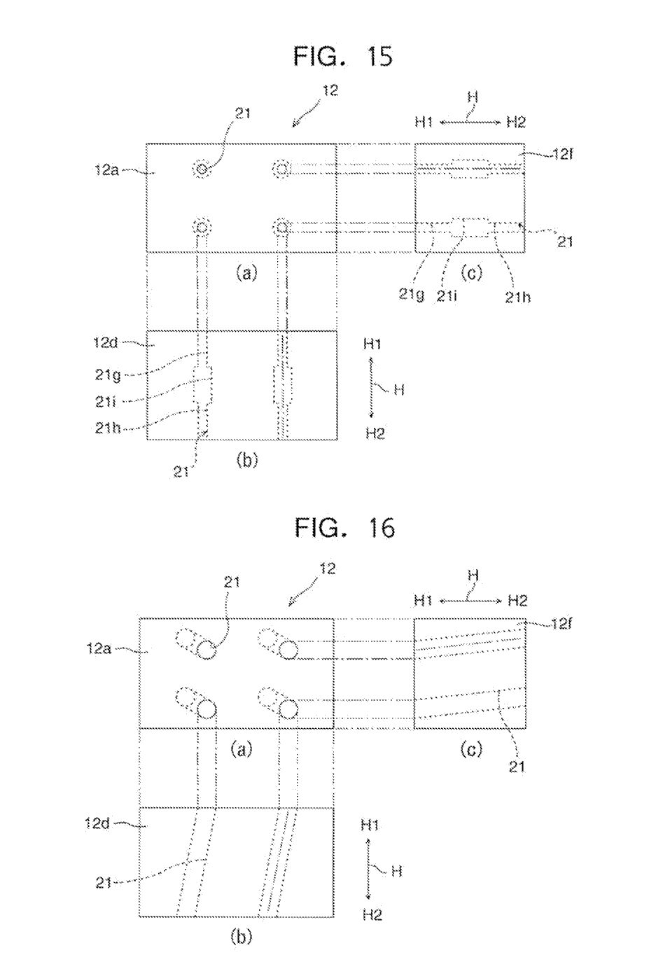

FIG. 17(d) is a schematic plan view of an anode body according to an eighth modified example. FIG. 17(b) is a schematic front view of the anode body according to the eighth modified example. FIG. 17(c) is a schematic side view of the anode body according to the eighth modified example.

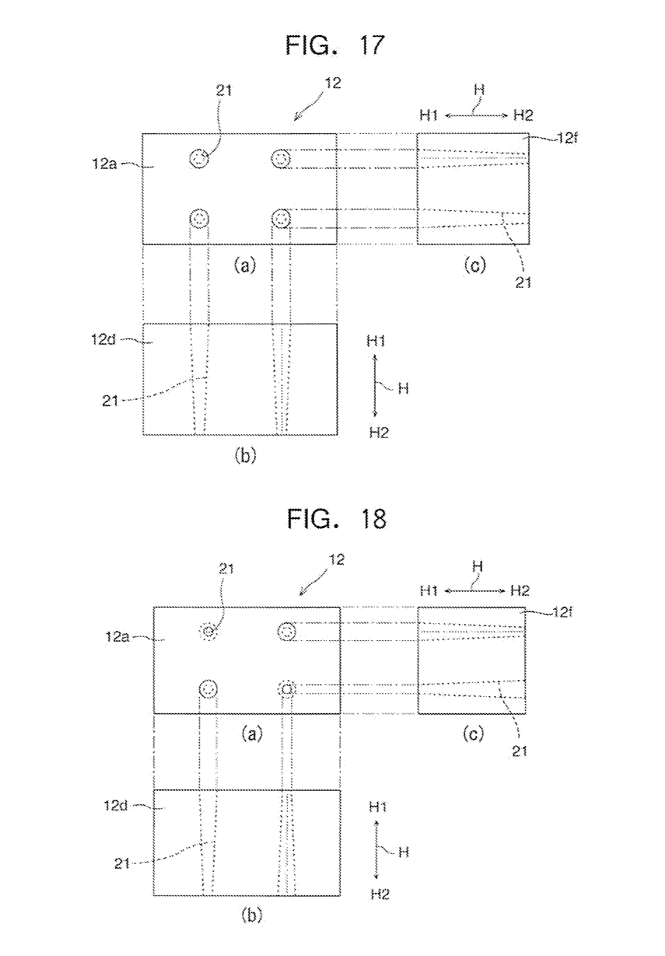

FIG. 18(a) is schematic plan view of an anode body according to a ninth modified example. FIG. 18(b) is a schematic front view of the anode body according to the ninth modified example. FIG. 18(c) is a schematic side view of the anode body according to the ninth modified example.

FIG. 19(a) is a schematic plan view of an anode body according to a tenth modified example. FIG. 19(b) is a schematic front view of the anode body according to the tenth modified example. FIG. 19(c) is schematic side view of the anode body according to the tenth modified example,

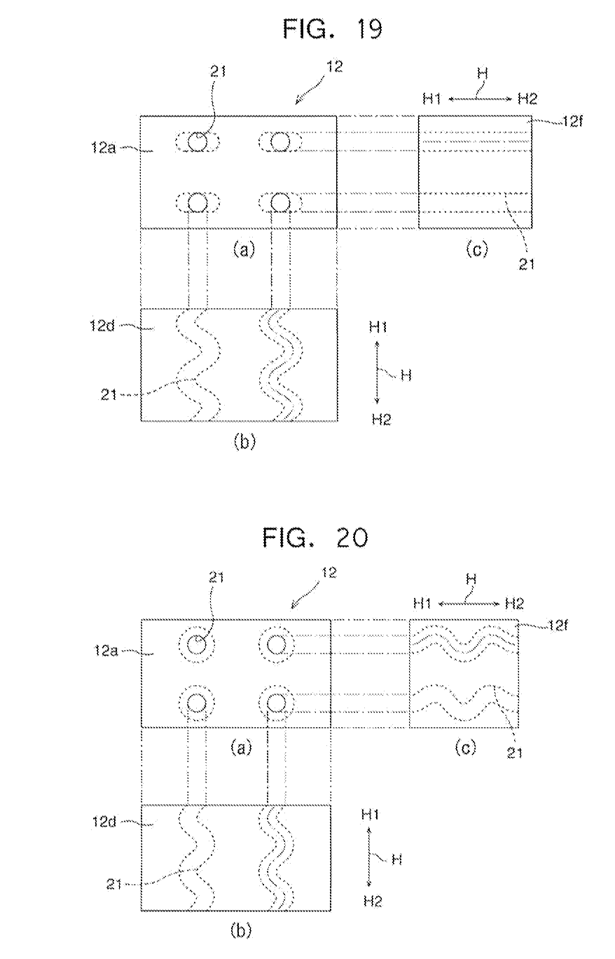

FIG. 20(a) is a schematic plan view of an anode body according to an eleventh modified example. FIG. 20(b) is a Schematic front view of the anode body according to the eleventh modified example. FIG. 20(c) is a schematic side view of the anode body according to the eleventh modified example.

In the first and the second embodiments and the first to the sixth modified examples explained above, through-hole 21 has a plurality of through-hole portions that have various shapes or center axes. However, the embodiments are not limited to these configurations.

For example, through-hole 21 may be formed into an inclined cylinder shape with a diameter which is unchanged in the elongating direction of through-hole 21 as shown in FIGS. 16(a)-16(c). Even in this case, the same effect as in the above-mentioned first and second embodiment may be obtained because the surface area to volume ratio (S/V) of through-hole 21 increases.

For example, when the center axis of the inclined cylinder-shaped through-hole 21 has an inclination angle of θ, the surface area of the inclined cylinder-shaped through-hole 21 is 1/COSθ times larger than that of the non-inclined cylinder-shaped through-hole having the same height. Accordingly, when the inclination angle is 30°, for instance, the surface area of through-hole 21 is approximately 1.15 times larger than that of the non-inclined cylinder-shaped through-hole having the same height. When the inclination angle is 45°, for instance, the surface area of through-hole 21 is approximately 1.4 times larger than that of the non-inclined cylinder-shaped through-hole having the same height. When the inclination angle is 60°, for instance, the surface area of through-hole 21 is approximately double the surface area of the non-inclined cylinder-shaped through-hole having the same height.

In the eighth modified example shown in FIGS. 17(a)-17(c), and the ninth modified example shown in FIGS. 18(a)-18(c), through-hole 21 is formed in a circular truncated cone shape whose diameter changes in height direction H. More specifically, in the eighth modified example, each of a plurality of through-holes 21 is formed in a circular truncated cone shape whose diameter gradually becomes smaller in height direction H from H1 side to H2 side. In the ninth modified example, a plurality of through-holes 21 include a plurality of through-holes that are formed in a circular truncated cone shape whose diameter gradually becomes smaller in height direction H from H1 side to H2 side, and a plurality of through-holes that are formed in a circular truncated one shape whose diameter gradually becomes smaller in height direction H from H2 side to H1 side. Even in this case, the same effect as in the above-mentioned the first and the second embodiment may be obtained because the surface area to volume ratio (S/V) of through-hole 21 increases.

In the tenth modified example shown in FIGS. 19(a)-19(c), through-holes 21 are formed in meandering shape in height direction H. In the eleventh modified example shown in FIGS. 20(a)-20(c), through-hole 21 is formed in a spiral shape in height direction H. Even in these cases, the same effect as in the above-mentioned first and second embodiment may be obtained because the surface area to volume ratio (S/V) of through-hole 21 increases.

Note that the anode body used in the seventh to the ninth modified examples may be formed, for example, by sintering after forming through-holes 21 on a pre-sintered anode body using punch needles.

Moreover, the anode body used in the tenth and eleventh modified examples may be formed, for example, by sintering the anode body in which a material that volatilizes during the sintering process is filled.

### EXAMPLE 1

A solid electrolytic capacitor having the same configuration as in the above-mentioned second embodiment except that through-hole 21 is formed in an inclined cylinder shape as shown in FIG. 16, is made in the following process.

As particles that include valve metals, tantalum power (average particle diameter is 1 μm) whose CV value (a product of capacitance of tantalum sintered body after forming an electrolytic oxide film and electrolysis voltage) is 50,000 [μF·V/g] is used. This tantalum powder and a binder made of mixture of acrylic resin and organic solvent are mixed to prepare a tantalum powder mixture. The tantalum powder mixture is molded into a 4.5 mm×3.3 mm×1.0 mm shape using a metal mold. Next, through-holes of inclined cylinder shape are formed at four spots on the molded tantalum powder mixture using a needle of 0.5 mm longer diameter and 0.43 mm shorter diameter in a NC punching process machine. The inclination angle of the through-hole is 30° to the direction perpendicular to the main surface.

Next, anode terminal 13 is fixed in the molded body having through-holes, and then the binder is removed under a reduced-pressure atmosphere. By sintering at 1100° C., anode body 12 in which anode terminal 13 is bonded is made.

Next, dielectric layer 14 made of oxide film is formed on a surface of anode body 12 by an anodic oxidation method. Specifically, anode body 12 is immersed in approximately 0.1 mass percentage of phosphoric acid aqueous solution kept at the temperature of approximately 60° C., and then applying approximately 10V voltage for 10 hours. Thus, dielectric layer 14 is formed.

Next, as a pre-coat layer, a polypyrrole film is formed on dielectric layer 14 by chemical polymerization. Specifically, anode body 12 having dielectric layer 14 is immersed in 20% IPA solution of toluenesulfonic acid iron (II), then immersed in pyrrole solution and dried. By repeating the procedure five times, polypyrrole film is formed. After forming the polypyrrole film, a reanodization process is performed for 2 hours as is done for forming dielectric layer 14.

After the reanodization process, conductive polymer layer 15a made of polypyrrole film is formed on polypyrrole film by electropolymerization. Specifically, a polymerizable solution made of a solution of 1 mass percentage of pyrrole and 2 mass percentage of sodium dodecylbenzene sulfonete is prepared. The polymerizable solution is prepared to have a pH of less than 5 by adding sulfuric acid. Anode body 12 that underwent the reanodization process is immersed in the pH-adjusted polymerizable solution filled in a stainless-steel container, and then, a stainless-steel electrode is pressed against the polypyrrole film to get contact with the polypyrrole film. A DC power source is connected between the stainless-steel container as a cathode and a stainless-steel electrode as an anode. By applying a constant current (0.1 mA per capacitor element) for 10 hours, conductive polymer layer 15a made of polypyrrole is formed.

Next, a carbon paste is applied and dried on conductive polymer layer 15a to form carbon paste layer 15b. Further, silver paste is applied and dried on carbon layer 15b to form silver paste layer 15c. Then, in order to expose an end portion of anode terminal 13, dielectric layer 14 and the like formed on anode electrode 13 is removed by grinding. Further, cathode lead frame 20 is connected to silver paste layer 15c by conductive adhesive 19. By a transfer Meld method, resin outer package 10 is formed, thus making 20 pieces of solid electrolytic capacitors A1 according to example 1.

### EXAMPLE 2

20 pieces of solid electrolytic capacitors A1 are made according to example 2 in the same manner as in example 1 except that anode terminal 13 is formed into a rod-shaped body whose end portion is embedded in anode body 12 as shown in FIG. 1.

More specifically, in the example, anode body 12 to which anode terminal 13 is bonded is made according to the following procedure. First, tantalum powder mixture prepared in the same manner as in example 1 is molded using a metallic mold into a molded body of 4.5 mm×3.3 mm×1.0 mm with a metallic tantalum wire having diameter of 0.5 mm, which later becomes anode terminal 13. Next, inclined cylinder-shaped through-holes are formed at four spots in the molded body as is done in the above-mentioned example 1. Then, the binder is removed and the molded body is sintered. Thus, anode body 12 to which anode, terminal 13 is bonded is made.

### EXAMPLE 3

20 pieces of solid electrolytic capacitors A3 are made according to example 2 in the same manner as in example 1 except that through-hole 21 has a shape as shown schematically in FIG. 10.

Specifically, in the example, anode body 12 is made according to the following procedure. First, a slurry is made by mixing tantalum powder and a binder in the same manner as in the above-mentioned example 1. Then, the slurry is formed into a sheet of 0.4 mm thickness using a doctor-blade method. Then, the sheet is dried in the air and cut into 100 mm square to make a green sheet.

Next, four cylinder-shaped holes of 500 μm per capacitor element are punched in the green sheet using a NC punching process machine. In this manner, three kinds, of green sheets each having a through-hole center shifted by 100 μm are made.

Next, these three kinds of green sheets are laminated in order to form a laminated body. The laminated body is the bonded by isostatic pressing. The press-bonded laminated body is cut into 4.5 mm×3.3 mm×1.0 mm chip-like components.

Then, the binder is removed and the laminated body is sintered in the same manner as in the above-mentioned example 1. Thus, an anode body to which anode terminal 13 is bonded is made.

Note in this example, a metal plate without a through-hole is used as anode terminal 13.

### EXAMPLE 4

20 pieces of solid electrolytic capacitors A4 are made according to example 4 in the same manner as example 3 except that a punched metal having through-holes of 0.3 mm diameter (80 through-holes per 0.2 cm²) is used as anode terminal 13.

### COMPARATIVE EXAMPLE 1

20 pieces of solid electrolytic capacitors B1 are made according to comparative example 1 in the same manner as in example 1 except that no through-holes are formed in an anode body.

### COMPARATIVE EXAMPLE 2

20 pieces of solid electrolytic capacitors B2 are made according to comparative example 2 in the same manner as in example 1 except that non-inclined cylinder-shaped through-holes of the same diameter as in example 1 are formed in an anode body instead of inclined cylinder-shaped through-holes.

Capacitance at a frequency of 120 Hz and ESR (Equivalent Series Resistance) at a frequency of 100 kHz of each of solid electrolytic capacitors A1-A4, B1 and B2 made according to the above-mentioned examples 1 to 4 and comparative examples 1 to 2 respectively, are measured using a LCR meter. In each example and comparative example, an average capacitance and an average ESR of 20 pieces of samples is calculated. Table 1 below shows the average capacitance and the average ESR of examples 1 to 4 and comparative examples 1 to 2.

TABLE 1

| Solid | Shape of | | Shape of | | ESR |
|---|---|---|---|---|---|
| Electrolytic | through- | | anode | Capacitance | value |
| Capacitor | hole | S/V | electrode | (μF) | (mΩ) |
| A1 | inclined | 8.6 | flat plate | 502 | 9.7 |
| A2 | inclined | 8.6 | Rod shape | 503 | 10.1 |
| A3 | Split- | 10.9 | flat plate | 515 | 9.5 |
| | level | | | | |
| A4 | Split- | 10.9 | flat plate | 518 | 9.5 |
| | level | | (punched | | |
| | | | metal) | | |
| B1 | h/a | — | flat plate | 354 | 12.5 |
| B2 | Cylinder | 8.0 | flat plate | 478 | 11.5 |
| | shape | | | | |

As shown in table 1 above, solid electrolytic capacitors A1-A4 indicate high average capacitance of approximately 510 μF and low average ESR of approximately 10 mΩ. Capacitors A1-A4 have a greater surface area to volume ratio (S/V) because the position of a portion of the outer circumference of through-hole 21 at first main surface 12a and the position of a portion of the outer circumference of through-hole 21 at a cross-section that is parallel to first main surface 12a are different when first main surface 12a is viewed from a normal direction. In contrast, solid electrolytic capacitor B1 whose anode body has no through-holes and solid electrolytic capacitor B2 whose anode body has cylinder-shaped through-holes have a low average capacitance and a high ESR. The result shows that a high capacitance and a low ESR can be achieved by forming through-holes of large surface area to volume ratio (S/V).

Further, solid electrolytic capacitor A3 having greater surface area to volume ratio (S/V) than that of solid electrolytic capacitor A2, has a higher capacitance and a lower ESR. From this result, one can see that the greater surface area to volume ratio (S/V), the higher capacitance as well as the lower ESR is obtained.

Moreover, the comparison of solid electrolytic capacitors A1 and A4 having anode electrode 13 connected on the outer surface of anode body 12 shows that anode terminal 13 having through-hole 13a can increase the capacitance and reduce ESR.

### EXAMPLES 5-8

20 pieces of solid electrolytic capacitors A5-A8 are made each according to examples 5-8 in the same manner as in the above-mentioned example 3 except that through-hole 21 is formed in a manner that the distance between centers of through-hole portion 21a and through-hole portion 21b is varied. The ratio of an overlapping area of through-hole portion 21a and through-hole portion 21b (overlapping area/areas of through-hole portion 21a and through-hole portion 21b) from a planar view is shown in table 2. Then, using solid electrolytic capacitors A5-A8, an average capacitance and an average ESR of 20 pieces of samples are calculated following the above-mentioned procedure. Table 2 below shows the results that also includes example 3.

TABLE 2

| | Distance | | | | |
|---|---|---|---|---|---|
| | between | | | | |
| Solid | centers of | Overlapping | | | ESR |
| Electrolytic | through- | area ratio | | Capacitance | value |
| Capacitor | holes (mm) | (%) | S/V | (μF) | (mΩ) |
| A5 | 0.40 | 10 | 13.4 | 492 | 10.5 |
| A6 | 0.29 | 30 | 12.2 | 512 | 9.8 |
| A3 | 0.20 | 50 | 10.9 | 515 | 9.5 |
| A7 | 0.12 | 70 | 9.8 | 510 | 9.7 |
| A8 | 0.04 | 90 | 8.6 | 488 | 10.8 |

From the result shown in table 2 above, one can see that when the ratio of an overlapping area of through-hole portion 21a and through-hole portion 21b is 10% to 90%, the capacitance is higher and the ESR is lower. Moreover, the result shows that when the ratio of an overlapping area of through-hole portion 21a and through-hole portion 21b is 30% to 70%, the capacitance is even higher and the ESR is even lower.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A solid electrolytic capacitor comprising:
an anode body;
a dielectric layer formed on the anode body; and
a conductive polymer layer formed on the dielectric layer;
wherein
the anode body, comprising a porous body and having a first surface and a second surface facing each other; and
a through-hole from the first surface to the second surface;
wherein
the through-hole has a first outer circumference at the first surface and a second outer circumference at a cross-section that is parallel to the first surface, and
the position of the second outer circumference viewed from a normal direction to the first surface differs from the position of the first outer circumference.

2. The solid electrolytic capacitor according to claim 1, wherein the through-hole comprises a plurality of through-hole portions with different center axes.

3. The solid electrolytic capacitor according to claim 2, wherein each through-hole portion of a through-hole has a different center axis arranged in a zigzag configuration with respect to the normal of the first surface opening of the through-hole.

4. The solid electrolytic capacitor according to claim 2, wherein the through-holes have columnar shapes.

5. The solid electrolytic capacitor according to claim 2, wherein an overlapping area of the plurality of the through-hole portions in a view of the normal direction to the first surface is 10% to 90%.

6. The solid electrolytic capacitor according to claim 2, wherein the ratio of total through-hole volume to total anode body volume is 0.05-0.15.

7. The solid electrolytic capacitor according to claim 1, further comprising an anode terminal that is connected to an outer surface of the anode body, wherein the anode terminal comprises through-holes.

8. The solid electrolytic capacitor according to claim 7, wherein anode terminal through-holes correspond to anode body through-holes.

9. A method of manufacturing a solid electrolytic capacitor comprising:
preparing an anode body, wherein the anode body comprising a porous body and having a first surface and a second surface facing each other; and
a through-hole formed from the first surface to the second surface; wherein
the through-hole has a first outer circumference at the first surface and a second outer circumference at a cross-section that is parallel to the first surface, and
the position of the second outer circumference viewed from a normal direction to the first surface differs from the position of the first outer circumference;
forming a dielectric layer on the anode body; and
forming a conductive polymer layer on the dielectric layer.

10. The method of manufacturing a solid electrolytic capacitor according to claim 9, wherein the through-hole has a plurality of through-hole portions with different center axes.

11. The method of manufacturing a solid electrolytic capacitor according to claim 9, wherein the step for preparing the anode body comprises:
forming through-holes in a plurality of green sheets that comprise valve metal particles;
laminating the plurality of green sheets; and
sintering the laminated green sheets.

12. The method of manufacturing a solid electrolytic capacitor according to claim 11, wherein the valve metal particles have sizes from 0.08 μm to 1 μm.

13. The method of manufacturing a solid electrolytic capacitor according to claim 11, wherein the center axes of the through-holes of the laminated green sheets are offset among the sheet layers.

14. The method of manufacturing a solid electrolytic capacitor according to claim 9, wherein the step for preparing the anode body further includes:
forming the through-hole in the anode body; and
sintering the anode body.

15. The method of manufacturing a solid electrolytic capacitor according to claim 14, wherein the through-hole in the anode body is formed with a punching needle.
